(19) United States
(12) Patent Application Publication
(10) Pub. No.: US 2025/0010720 A1
(43) Pub. Date: Jan. 9, 2025

(54) METHOD, COMPUTER PROGRAM AND APPARATUS FOR CONTROLLING AN AUGMENTED REALITY DISPLAY DEVICE

(71) Applicant: Continental Automotive Technologies GmbH, Hannover (DE)

(72) Inventors: Marko Zühlsdorf, Haibach (DE); Eugen Vetsch, Darmstadt (DE)

(73) Assignee: Continental Automotive Technologies GmbH, Hannover (DE)

(21) Appl. No.: 18/711,786

(22) PCT Filed: Nov. 22, 2022
(86) PCT No.: PCT/DE2022/200274

§ 371 Date: May 20, 2024

(30) Foreign Application Priority Data
Nov. 26, 2021 (DE) 10 2021 213 332.0

(51) Int. Cl. B60K 35/28; B60K 35/23

(52) U.S. Cl. CPC B60K 35/28; B60K 35/23; B60K 2360/177; B60K 2360/1868

(57) ABSTRACT

The present disclosure relates to a method, a computer program having instructions, and a device for controlling an augmented reality display device. The disclosure also relates to an augmented reality display device which uses such a device or such a method. In a first step, data relating to a driving situation of the vehicle are captured. Based on these data, it is determined whether there is a driving situation requiring action in which it may be necessary to present augmented reality information at the edge of or outside an eyebox of the augmented reality display device. A position of the eyebox is then adjusted with respect to an observer in such a way that the augmented reality information to be presented can be presented within the eyebox.

### CROSS REFERENCE TO RELATED APPLICATIONS

This US patent application claims the benefit of PCT patent application No. PCT/DE2022/200274, filed Nov. 22, 2022, which claims the benefit of German patent application No. 10 2021 213 332.0, filed Nov. 26, 2021, both of which are hereby incorporated by reference.

### TECHNICAL FIELD

The present disclosure relates to a method, a computer program having instructions, and a device for controlling an augmented reality display device. The disclosure also relates to an augmented reality display device which uses such a device or such a method.

### BACKGROUND

Such augmented reality display devices can be used, for example, for a head-up display for a vehicle. A head-up display, also referred to as HUD, is understood as meaning a display system in which the observer can maintain their viewing direction since the contents to be represented are inserted into their field of view. While such systems were originally used primarily in the aviation sector due to their complexity and costs, they are now also being used in large-scale production in the automotive sector.

Head-up displays generally comprise a picture generating unit (PGU), an optical unit, and a mirror unit. The picture generating unit generates the image and for this purpose uses at least one display element. The optical unit directs the image onto the mirror unit. The mirror unit is a partially reflecting, light-transmissive pane. The observer thus sees the contents represented by the picture generating unit as a virtual image and sees the real world behind the pane at the same time. In the automotive sector, the windshield is often used as mirror unit, and its curved shape must be taken into account in the representation. Due to the interaction between the optical unit and the mirror unit, the virtual image is an enlarged representation of the image produced by the picture generating unit. The picture generating unit and the optical unit are generally delimited with respect to the environment by a housing having a transparent cover. For head-up displays, at the present time use is usually made of a liquid crystal display (LCD) with an illumination unit for the picture generating unit.

The observer can see the virtual image only from the position of the so-called eyebox. The eyebox refers to a region, the height and width of which correspond to a theoretical viewing window. As long as one of the observer's eyes is located within the eyebox, all elements of the virtual image are visible to that eye. If, on the other hand, the eye is located outside the eyebox, the virtual image is visible only partially or not at all to the observer. The larger the eyebox, the less restricted the observer thus is in choosing their seating position. The size of the eyebox is limited, due to its design, by limitations of the light path in the device and in the installation slot. Under the design conditions, the eyebox is usually designed for adjustment to observers in different seating positions in a vertically repositionable manner. To adjust the position of the eyebox, an adjustment of one of the mirrors in the head-up display is usually used.

In some cases, e.g. for augmented reality applications or for reasons of comfort, a large and static eyebox is used, from which the observer can see the virtual image.

Against this background, EP 3 128 357 A2 describes a display device having a display panel, which provides an image containing driving information, a concave mirror, which reflects the image for generating a virtual image for a driver on a windshield, a detection unit, which detects a position of the driver, a drive unit, which moves the concave mirror, and a control unit. The control unit controls the drive unit such that the concave mirror is moved in order to move an eyebox when the detection unit detects a change in the position of the driver.

An essential feature of augmented reality head-up displays is the ability to augment a region of the vehicle environment using the display contents of the head-up display. In particular, the road ahead is overlaid with navigation symbols, for example. The width of the surrounding region that can be augmented is defined by the size of the virtual image, which is determined by the width of the aspherical mirror used in conventional head-up displays using mirrors.

The size of the aspherical mirror, and thus the image size, is usually limited by installation space specifications in the vehicle. Especially when cornering, but also on multi-lane freeways, part or even the entire road falls out of the augmentation region of the head-up display, which means that the main functions of the augmented reality head-up display cannot be used in these cases.

### SUMMARY

It is an object of the present disclosure to provide improved solutions for controlling an augmented reality display device.

This object is achieved by a method having the features of claim 1, by a computer program having instructions having the features of claim 7, by a device having the features of claim 8, and by a display device having the features of claim 9. The dependent claims relate to preferred configurations of the disclosure.

According to a first aspect of the disclosure, a method for controlling an augmented reality display device comprises the steps of determining whether there is a driving situation requiring action in which it may be necessary to present augmented reality information at the edge of or outside an augmentation region of the augmented reality display device; and adjusting a position of the augmentation region with respect to an observer in such a way that the augmented reality information to be presented can be presented within the augmentation region.

According to a further aspect of the disclosure, a computer program comprises instructions which, when executed by a computer, cause the computer to carry out the following steps for controlling an augmented reality display device of determining whether there is a driving situation requiring action in which it may be necessary to present augmented reality information at the edge of or outside an augmentation region of the augmented reality display device; and adjusting a position of the augmentation region with respect to an observer in such a way that the augmented reality information to be presented can be presented within the augmentation region.

The term computer should be broadly understood. In particular, it also comprises control units, embedded systems, and other processor-based data processing devices.

The computer program may be provided for electronic retrieval or may be stored on a computer-readable storage medium, for example.

According to a further aspect of the disclosure, a device for controlling an augmented reality display device comprises an evaluation module for determining whether there is a driving situation requiring action in which it may be necessary to present augmented reality information at the edge of or outside an augmentation region of the augmented reality display device; and a control module for adjusting a position of the augmentation region with respect to an observer in such a way that the augmented reality information to be presented may be presented within the augmentation region.

In the solution according to the disclosure, a position of the augmentation region is shifted horizontally depending on the situation in such a way that augmented reality information to be presented lies within the available augmentation region. Similar to a cornering light, parts of the road that are further out may therefore also be augmented in the display region of the augmented reality display device without having to realize an enlarged augmentation region for this.

According to one aspect of the disclosure, the presence of a driving situation requiring action is determined when cornering is imminent or takes place. When cornering, it is expected that important augmented reality information is expected along the course of the bend. Therefore, the augmentation region is adjusted accordingly. This is done regardless of whether the driver is already looking there. This also has the advantage that the shifting of the augmentation region encourages the driver to look in the direction in which important augmented reality information is expected. For example, the driver unconsciously turns their gaze to the left when augmented reality elements that are perceived by the driver only at the edge of their field of view appear on the left.

According to one aspect of the disclosure, cornering is determined from data from an acceleration sensor, from data from an environmental sensor system or from map data. Lateral acceleration of the vehicle indicates cornering. Vehicles with an augmented reality display device already necessarily require an inertial measuring unit which comprises inertial sensors such as acceleration sensors and rate-of-rotation sensors. These may also be used to horizontally reposition the augmentation region. The lateral vehicle movements, in particular yaw movements, have a relatively low frequency in normal driving maneuvers and may be detected with the inertial measuring unit and forwarded via a logic unit to an adjustment unit for horizontally repositioning the augmentation region. In addition, the steering wheel angle may also be detected by sensors. This occurs shortly before the wheels deflect in the direction of the bend. This allows imminent cornering to be anticipated. Alternatively, however, cornering may also be determined from data from an environmental sensor system. For example, cornering may be derived from images from a camera by evaluating a curvature of the road markings. Map data also indicate an imminent bend and allow the augmentation region to be shifted according to the expected bend.

According to one aspect of the disclosure, the presence of a driving situation requiring action is determined when augmented reality information is intended to be presented on a lane at a distance from a current lane. In various driving situations, it may be desirable to display augmented reality information on a parallel lane further away from the current lane. If this parallel lane is not currently covered by the augmentation region, the augmentation region is shifted such that augmented reality information may be displayed on the desired parallel lane.

According to one aspect of the disclosure, augmented reality information is presented on a lane at a distance from a current lane when a lane change of the vehicle is due or a lane change of a vehicle in front takes place. It is possible to recognize from navigation data or map information that there are multiple lanes and that turning information should be displayed on a parallel lane further away from the current lane. The augmentation region is therefore shifted if necessary such that augmented reality information may also be displayed on this parallel lane even before the vehicle changes lane. In vehicles with adaptive cruise control (ACC) a vehicle in front is automatically followed and a corresponding distance to it is maintained. To illustrate automatic following, the vehicle in front may be augmented by the augmented reality display device. If this vehicle is now changing lane, augmented reality information to be displayed may be outside the current augmentation region. The augmentation region may then be repositioned accordingly. Another use case of augmented reality is the indication of side traffic, e.g. at an intersection. Currently, this could only be done with direction arrows, since the augmentation region does not reach sufficiently far to the right or left. By contrast, by shifting the augmentation region according to the disclosure, dangerous situations may be indicated earlier, e.g. a cyclist in a crossroad or a pedestrian on a crosswalk. This increases the safety of the persons involved.

According to one aspect of the disclosure, the adjustment of the position of the augmentation region involves tilting a curved mirror of the augmented reality display device about a vertical axis. An easy possible way of adjusting the position of the augmentation region is to tilt a curved mirror horizontally in the optical path of the display device. The axis of rotation is essentially parallel to the z-axis of the vehicle. Tilting the curved mirror horizontally shifts the virtual image horizontally. Due to the possibility of tilting, the curved mirror does not need the size that would normally result from projecting the entire virtual image onto the curved mirror. The dynamic width of the virtual image is thus decoupled from installation space specifications and results from the rotation path of the curved mirror.

If the curved mirror is rotated horizontally or vertically, the eyebox, in which the virtual image is displayed to the driver, is also shifted. It is shifted in the opposite direction to the virtual image, with the pivotal point typically just in front of the windshield on the street side. Due to the leverage effect and the long projection path, which is usually present in particular in an augmented reality head-up display, a small shift of the eyebox results in a relatively large shift of the virtual image in the opposite direction. This small shift of the eyebox may usually be easily compensated for by the driver. Especially when cornering, i.e. one of the use cases of the invention, the body and head are pushed in the opposite direction anyway by the inertia force and thus in the same direction as the eyebox.

Preferably, an augmented reality display device according to the disclosure is used in a head-up display, e.g. a head-up display for a motor vehicle.

### BRIEF DESCRIPTION OF THE DRAWINGS

Further features of the present invention will become apparent from the following description and the appended claims in conjunction with the figures, wherein:

FIG. 1 schematically shows a head-up display according to the prior art for a motor vehicle;

FIG. 2 schematically shows a head-up display with an augmented reality display device according to the disclosure;

FIG. 3 illustrates adjustment of an augmentation region to cornering;

FIG. 4 schematically shows a vehicle with a head-up display that uses an augmented reality display device according to the disclosure;

FIG. 5 schematically shows a method for controlling an augmented reality display device of a vehicle;

FIG. 6 schematically shows a first embodiment of a device for controlling an augmented reality display device of a vehicle; and

FIG. 7 schematically shows a second embodiment of a device for controlling an augmented reality display device of a vehicle.

### DETAILED DESCRIPTION

For a better understanding of the principles of the present disclosure, embodiments of the disclosure are explained in more detail below with reference to the figures. Identical reference signs are used for identical or functionally identical elements in the figures and are not necessarily described again for each figure. It goes without saying that the invention is not restricted to the embodiments represented and that the features described can also be combined or modified without departing from the scope of protection of the disclosure as defined in the appended claims.

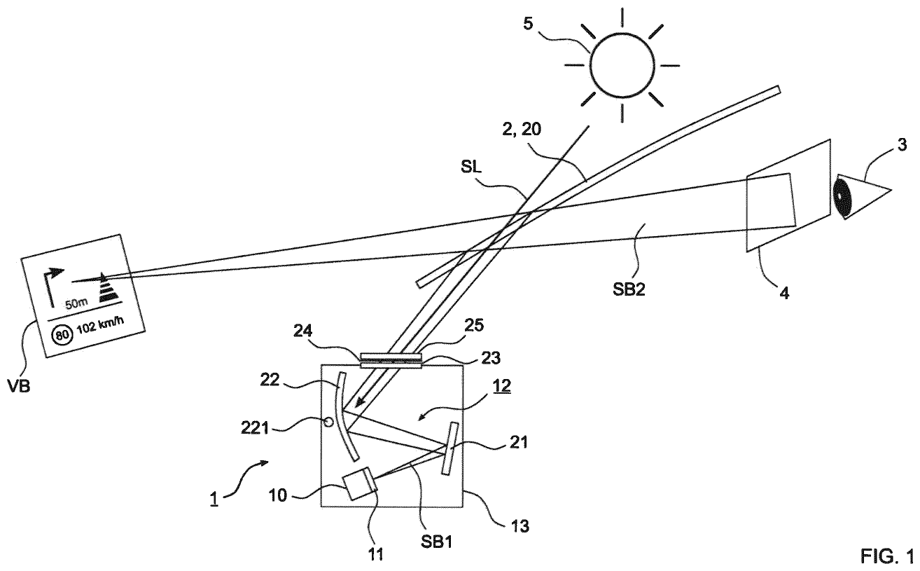

FIG. 1 shows a schematic diagram of a head-up display according to the prior art for a motor vehicle. The head-up display has a display device 1 having a picture generating unit 10 and an optical unit 12. A beam SB1 emanates from a display element 11 and is reflected by a folding mirror 21 onto a curved mirror 22 that reflects said beam in the direction of a mirror unit 2. The mirror unit 2 is illustrated here as a windshield 20 of the motor vehicle. From there, the beam SB2 travels in the direction of an eye of an observer 3.

The observer 3 sees a virtual image VB that is located outside the motor vehicle above the engine hood or even in front of the motor vehicle. Due to the interaction between the optical unit 12 and the mirror unit 2, the virtual image VB is an enlarged representation of the image displayed by the display element 11. A speed limit, the current vehicle speed and navigation instructions are symbolically represented here. As long as the eye of the observer 3 is located within an eyebox 4, indicated by a rectangle, all elements of the virtual image VB are visible to the observer 3. If the eye of the observer 3 is located outside of the eyebox 4, the virtual image VB is visible only partially or not at all to the observer 3. The larger the eyebox 4, the less restricted the observer is when choosing their seating position.

The curvature of the curved mirror 22 is adapted to the curvature of the windshield 20 and ensures that the image distortion is stable over the entire eyebox 4. The curved mirror 22 is mounted so as to be rotatable about a horizontal axis by means of a bearing 221. The rotation of the curved mirror 22 that this allows makes it possible to shift the eyebox 4 and thus to adapt the position of the eyebox 4 to the position of the observer 3. The folding mirror 21 serves to ensure that the path traveled by the beam SB1 between the display element 11 and the curved mirror 22 is long and at the same time the optical unit 12 is nevertheless compact. The picture generating unit 10 and the optical unit 12 are delimited with respect to the environment by a housing 13 having a transparent cover 23. The optical elements of the optical unit 12 are thus protected, for example, against dust in the interior of the vehicle. An optical film or a polarizer 24 may furthermore be located on the cover 23. Anti-glare protection 25 serves to reliably absorb the light reflected via the interface of the cover 23 so that the observer is not dazzled. In addition to the sunlight SL, the light from another stray light source 5 may also reach the display element 11. In combination with a polarization filter, the polarizer 24 allows incident sunlight SL to be reduced.

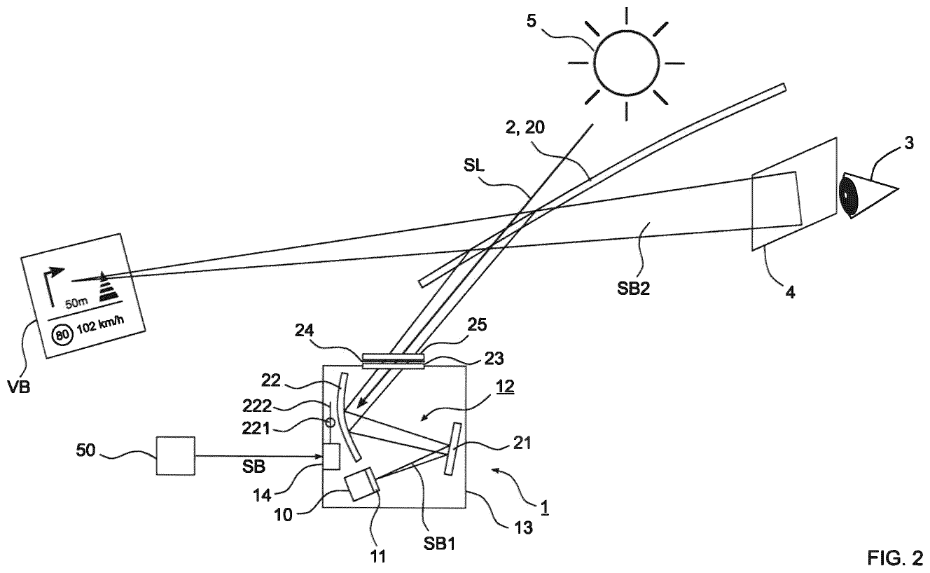

FIG. 2 schematically shows a head-up display with an augmented reality display device 1 according to the disclosure. The head-up display largely corresponds to the head-up display from FIG. 1, but the curved mirror 22 in this case is also rotatable about a vertical axis 222. A motor 14, for example a linear stepper motor, is used to adjust the curved mirror 22 about the vertical axis 222. For this purpose, the motor 14 receives corresponding control commands SB from a device 50 for controlling the augmented reality display device 1.

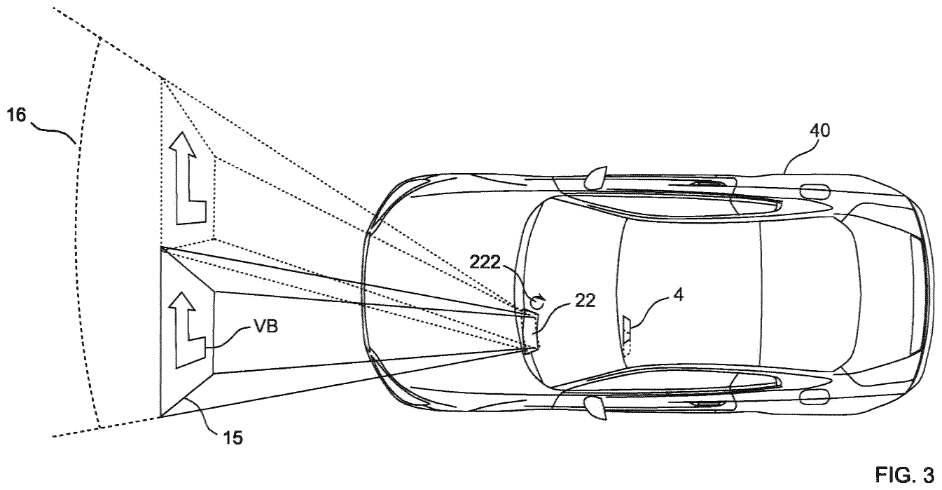

FIG. 3 illustrates adjustment of an augmentation region 15 to cornering of a vehicle 40. When driving straight ahead, the rotatable curved mirror 22 is in a central position. The associated augmentation region 15, in which a virtual image VB may be presented, is centrally located in front of the driver. The eyebox 4 is also accordingly centered on the driver. In the case of cornering, the curved mirror 22 is tilted slightly by means of a motor about a vertical axis 222. This causes the augmentation region 15 and the eyebox 4 to be shifted in opposite directions. In the example illustrated, the augmentation region 15 is shifted to the right and the eyebox 4 is shifted to the left. This makes it possible to cover a significantly enlarged virtual field of view 16. The shift is illustrated in an exaggerated form in FIG. 3 for clarification.

For head-up displays with a large static eyebox 4 without an adjustment option, there are no adjustment units for the mirrors. In this case, a linear stepper motor adjustment can be provided for the motor 14, which induces a horizontal rotation of the curved mirror 22.

Head-up displays with a dynamic position of the eyebox 4 already have an adjustment unit for vertical image shifting. When this dynamic adjustment of the eyebox 4 is carried out on the curved mirror 22, a second, coupled stepper motor can be provided for the motor 14 in order to be able to adjust both directions. If the dynamic adjustment of the eyebox 4 is carried out instead, e.g., on a folding mirror, a linear stepper motor adjustment of the curved mirror 22 may again be provided for the motor 14.

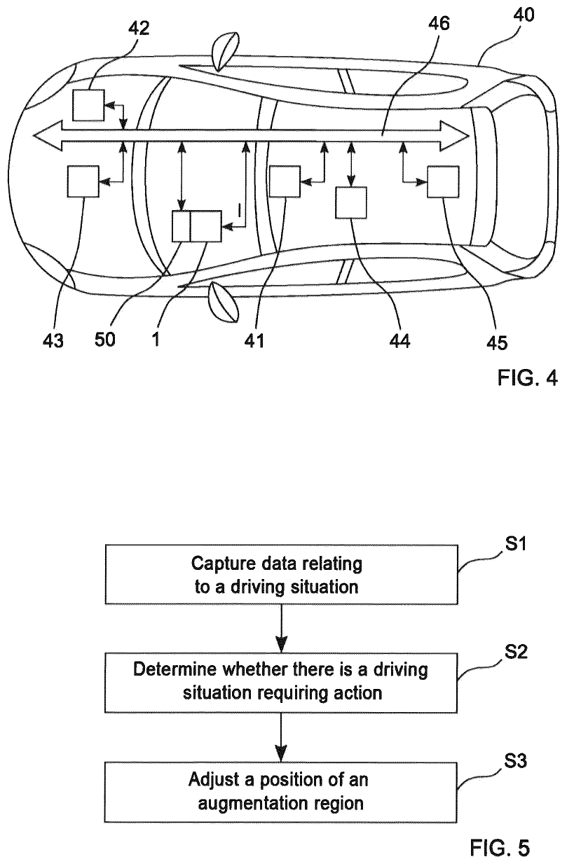

FIG. 4 schematically shows a vehicle 40 in which a solution according to the disclosure is implemented. In this example, the vehicle 40 is a motor vehicle. The motor vehicle has an augmented reality display device 1 according to the disclosure which in this case is part of a head-up display. The augmented reality display device 1 makes it possible to present augmented reality information I. The augmented reality display device 1 is controlled by a device 50. For example, data relating to the vehicle environment may be captured with a sensor system 41. The sensor system 41 may comprise in particular environment recognition sensors, for example ultrasonic sensors, laser scanners, radar sensors, lidar sensors, or cameras. The information captured by the sensor system 41 may be used to generate contents to be displayed for the head-up display. Accelerations of the motor vehicle may be captured with an acceleration sensor 42. Cornering of the motor vehicle may be determined from the accelerations captured by the acceleration sensor 42. Further parts of the motor vehicle in this example are a navigation system 43, which may be used to provide position information, and also a data transfer unit 44. By way of example, a connection to a backend, for example for receiving updated software for components of the motor vehicle, may be established by means of the data transfer unit 44. A memory 45 is present for storing data. Data are exchanged between the various components of the motor vehicle via a network 46.

FIG. 5 schematically shows a method for controlling an augmented reality display device of a vehicle. In a first step, data relating to a driving situation of the vehicle are captured S1. Based on these data, it is determined S2 whether there is a driving situation requiring action in which it may be necessary to present augmented reality information at the edge of or outside an augmentation region of the augmented reality display device. This is the case, for example, when cornering is imminent or taking place, which can be determined from data from an acceleration sensor, from data from an environmental sensor system or from map data. This may also be the case if, for example, a lateral road user is detected on the basis of data from the environmental sensor system. In particular, data from a camera, a lidar sensor or a radar sensor can be evaluated for this purpose. A driving situation requiring action may also exist if augmented reality information is intended to be presented on a lane adjacent to a current lane. This may be the case, for example, when a lane change of the vehicle is due or a lane change of a vehicle in front takes place. A position of the augmentation region is then adjusted with respect to an observer S3 in such a way that the augmented reality information to be presented may be presented within the augmentation region. For this purpose, for example, a curved mirror of the augmented reality display device can be tilted about a vertical axis.

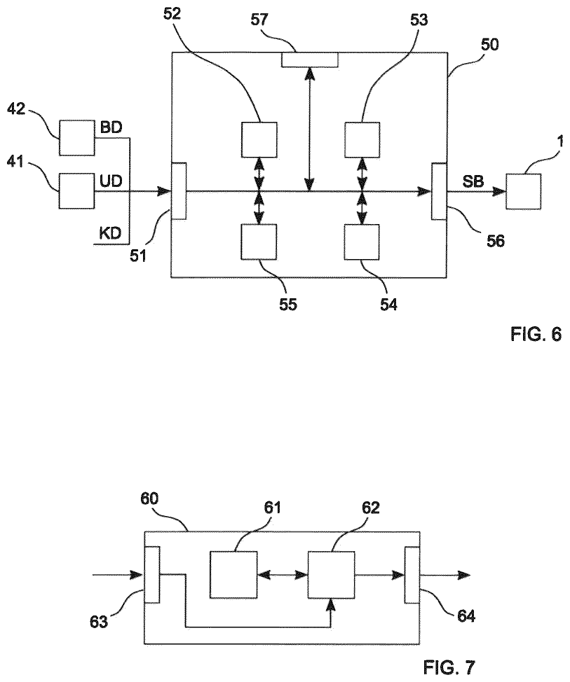

FIG. 6 shows a simplified schematic representation of a first embodiment of a device 50 for controlling an augmented reality display device 1 of a vehicle. The device 50 has an input 51 which may be used to receive, for example, data BD from an acceleration sensor 42, data UD from an environmental sensor system 41 or map data KD. An evaluation module 52 is configured to determine, on the basis of the received data, whether there is a driving situation requiring action in which it may be necessary to present augmented reality information at the edge of or outside an augmentation region of the augmented reality display device 1. This is the case, for example, when cornering is imminent or taking place, which may be determined from data BD from the acceleration sensor 42, from the data UD from the environmental sensor system 41 or from the map data KD. A driving situation requiring action may also exist if augmented reality information is intended to be presented on a lane adjacent to a current lane. This can be the case, for example, when a lane change of the vehicle is due or a lane change of a vehicle in front takes place. A control module 53 is configured to adjust a position of the augmentation region with respect to an observer in such a way that the augmented reality information to be presented can be presented within the augmentation region. For this purpose, the control module 53 can output a corresponding control command SB via an output 56 of the device 50 to the augmented reality display device 1. In response to the control command SB, for example, a curved mirror of the augmented reality display device 1 can be tilted about a vertical axis.

In FIG. 6, the device 50 is illustrated as an independent component. Of course, however, it can also be integrated in the augmented reality display device 1, in a central vehicle computer or in another component.

The evaluation module 52 and the control module 53 may be controlled by a monitoring module 54. Settings of the evaluation module 52, the control module 53 or the monitoring module 54 may be changed, if necessary, via a user interface 57. The data that accrue in the device 50 may be stored in a memory 55 of the device 50 if necessary, for example for later evaluation or for use by the components of the device 50. The evaluation module 52, the control module 53 and the monitoring module 54 may be implemented as dedicated hardware, for example as integrated circuits. Of course, they may however also be partially or completely combined or implemented as software that runs on a suitable processor, for example a GPU or a CPU. The input 51 and the output 56 may be implemented as separate interfaces or as a combined interface.

FIG. 7 shows a simplified schematic representation of a second embodiment of a device 60 for controlling an augmented reality display device of a vehicle. The device 60 has a processor 62 and a memory 61. For example, the device 60 is a control unit or an embedded system. The memory 61 stores instructions which, when executed by the processor 62, cause the device 60 to carry out the steps according to one of the methods described. The instructions stored in the memory 61 thus embody a program which is executable by the processor 62 and which realizes the method according to the disclosure. The device 60 has an input 63 for receiving information. Data generated by the processor 62 are provided via an output 64. They may also be stored in the memory 61. The input 63 and the output 64 may be combined to form a bidirectional interface.

The processor 62 may comprise one or more processor units, for example microprocessors, digital signal processors, or combinations thereof.

The memories 55, 61 of the described devices may have both volatile and nonvolatile memory areas and may comprise a wide variety of storage devices and storage media, for example hard disks, optical storage media, or semiconductor memories.

1. A method for controlling an augmented reality display device of a vehicle, the method comprising:
determining whether there is a driving situation requiring action in which it may be necessary to present augmented reality information at the edge of or outside an augmentation region of the augmented reality display device; and
adjusting the augmentation region with respect to an observer in such a way that the augmented reality information to be presented can be presented within the augmentation region.

2. The method as claimed in claim 1, wherein the presence of the driving situation requiring action is determined when cornering is imminent or takes place.

3. The method as claimed in claim 2, wherein cornering is determined from data from an acceleration sensor, from data from an environmental sensor system or from map data.

4. The method as claimed in claim 1, wherein the presence of the driving situation requiring action is determined when augmented reality information is intended to be presented on a lane at a distance from a current lane.

5. The method as claimed in claim 4, wherein augmented reality information is presented on the lane at a distance from the current lane when a lane change of the vehicle is due or a lane change of a vehicle in front takes place.

6. The method as claimed in claim 1, wherein the adjustment of the position of the augmentation region involves tilting a curved mirror of the augmented reality display device about a vertical axis.

7. A computer program having instructions which, when executed by a computer, cause the computer to carry out the steps of a method, the method comprising:
determining whether there is a driving situation requiring an action in which it may be necessary to present augmented reality information at the edge of or outside an augmentation region of the augmented reality display device; and
adjusting the augmentation region with respect to an observer in such a way that the augmented reality information to be presented can be presented within the augmentation region.

8. A device for controlling an augmented reality display device of a vehicle, comprising:
an evaluation module for determining whether there is a driving situation requiring action in which it may be necessary to present augmented reality information at the edge of or outside an augmentation region of the augmented reality display device; and
a control module for adjusting a position of the augmentation region with respect to an observer in such a way that the augmented reality information to be presented can be presented within the augmentation region.

9. An augmented reality display device for a vehicle, wherein the augmented reality display device comprises:
a device, comprising:
an evaluation module for determining whether there is a driving situation requiring action in which it may be necessary to present augmented reality information at the edge of or outside an augmentation region of the augmented reality display device; and
a control module for adjusting a position of the augmentation region with respect to an observer in such a way that the augmented reality information to be presented can be presented within the augmentation region.

10. The augmented reality display device as claimed in claim 9, wherein the augmented reality display device is part of a head-up display.
